(19) United States
(12) Patent Application Publication
(10) Pub. No.: US 2005/0138233 A1
(43) Pub. Date: Jun. 23, 2005

(54) Direct memory access control

(75) Inventors: Vasu J. Bibikar, Austin, TX (US); Sreevathsa Ramachandra, Austin, TX (US); Mark N. Fullerton, Austin, TX (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/742,938

(22) Filed: Dec. 23, 2003

(51) Int. Cl. G06F 13/28

(52) U.S. Cl. 710/24

(57) ABSTRACT

Direct memory access control may utilize a direct memory access register adapted to hold a descriptor.

### BACKGROUND

Direct memory access generally refers to memory access that does not involve transferring data through a processor and is frequently used for data transfer between memories. The processor, however, generally controls and monitors the direct memory access process, which prevents the processor from performing other functions or being placed in a low power mode. In addition, for the processor to control and monitor the direct memory access process, interrupts and interrupt handlers for the processor are generally needed.

### BRIEF DESCRIPTION OF THE DRAWINGS

The invention may be understood by referring to the following description and accompanying drawings that are used to illustrate embodiments of the invention, where the same reference numerals refer to the same features. In the drawings:

FIG. 1 shows a data transfer system for an exemplary embodiment of the invention.

FIG. 2 shows a direct memory access register holding a descriptor for an exemplary embodiment of the invention.

FIG. 3 shows a control status register for an exemplary embodiment of the invention.

FIG. 4 shows the three types of descriptors in a descriptor chain for an exemplary embodiment of the invention.

FIG. 5 shows a flow diagram for data transfer for an exemplary embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment,” “an embodiment,” “example embodiment,” “exemplary embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

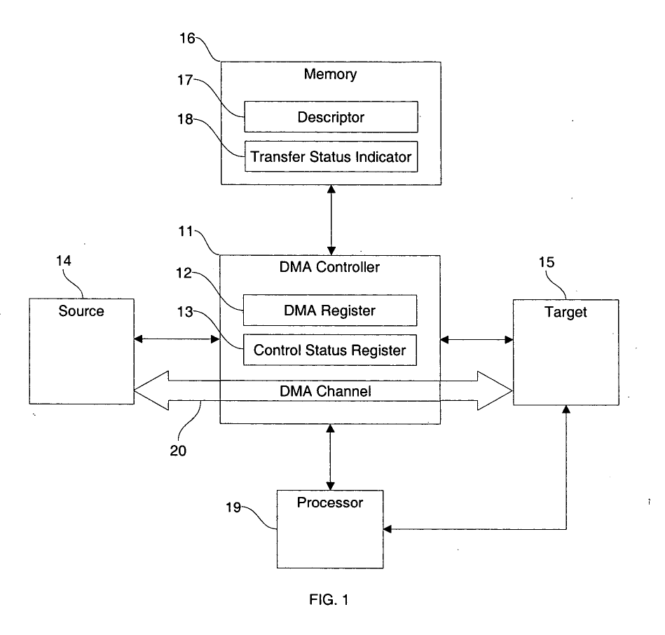

FIG. 1 shows a data transfer system for an exemplary embodiment of the invention. The data transfer system may include a direct memory access (DMA) controller 11 having a DMA register 12 and a control status register 13. The DMA controller may include circuitry and/or one or more processors. The DMA controller 11 may be used to transfer data from a source 14 to a target 15. The source 14 and target 15 may be, for example, memories, data storage devices, machine-readable media, or one or more devices, apparatuses, systems for holding data.

The DMA controller 11 may communicate with a memory 16 having one or more descriptors 17 and a transfer status indicator 18. The memory 16 is illustrated as being external to the DMA controller 11. In various embodiments, the memory 16, or any portion of the memory 16, may be internal and/or external to the DMA controller 11. The transfer status indicator 18 may be information related to the status of the data transfer (e.g., one or more flags and/or status-related bits). For example, the transfer status indicator may indicate when the target 15 is full or when the target 15 is becoming full. The transfer status indicator 18 is illustrated as being internal to the memory 16. In various embodiments, transfer status indicator 18 may be internal and/or external to the memory 16 and may be internal and/or external to the DMA controller 11.

To transfer data from the source 14 to the target 15, a processor 19 may activate a DMA channel 20. The processor 19 may be external to the DMA controller 11. The DMA channel 20 is illustrated as being internal to the DMA controller 11. When the DMA channel 20 is activated, the control status register 13 may hold configuration information for the DMA channel 20. Further, once the DMA channel 20 is activated, the DMA controller 11 may fetch one of the descriptors 17 from the memory 16 and store the fetched descriptor in the DMA register 12.

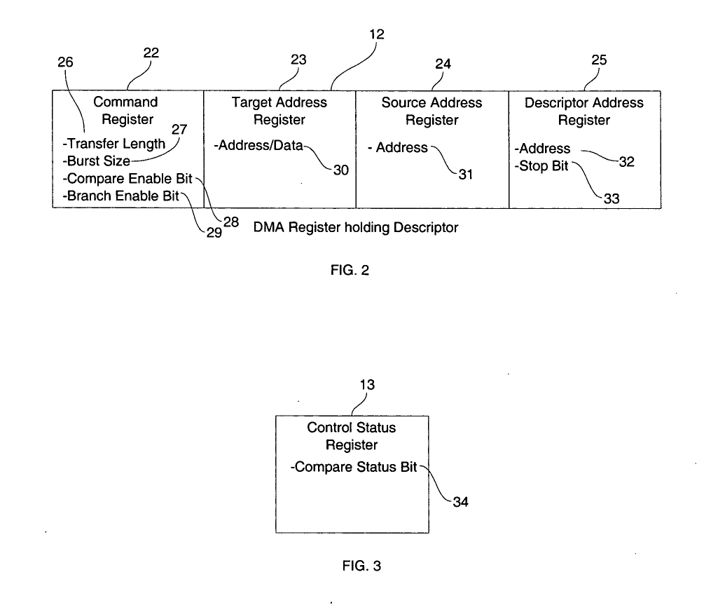

FIG. 2 shows a DMA register holding a descriptor for an exemplary embodiment of the invention. The descriptor may be a first descriptor in a descriptor chain, a last descriptor in a descriptor chain, or a descriptor between the first descriptor and the last descriptor in a descriptor chain. The descriptor chain may be cyclic or non-cyclic. Each descriptor 17 in the memory 16 may have the same data structure as the descriptor held in the DMA register 12 of FIG. 2. The DMA register 12 may include a command register 22, a target address register 23, a source address register 24, and a descriptor address register 25.

The source address register 24 may include an address 31 of a source for the data transfer. The address 31 may indicate a location of the data to be transferred. The address 31 may be, for example, an address of the source 14 or an address of the transfer status indicator 18.

The target address register 23 may include an address 30 of a target for the data transfer. The address 30 may indicate the location to where the data is to be transferred. The address 30 may be, for example, an address of the target 15 or data to be used for a comparison operation performed by the DMA controller 11.

The command register 22 may include transfer related details, for example, transfer length 26, burst size 27, a compare enable bit 28, and a branch enable bit 29.

The transfer length 26 may identify a total amount of data to be transferred, and the burst size 27 may identify an incremental amount of data to be transferred or a rate at which the data is to be transferred. For example, if the transfer length 26 is L bytes, and if the burst size 27 is S bytes, a total of L bytes may be transferred from the source 14 to the target 15 in bursts of S bytes. For example, if the transfer length 26 is 0 bytes, no data is to be transferred, and the descriptor is the end of a non-cyclic descriptor chain.

The compare enable bit 28 may indicate to the DMA controller 11 when to perform an operation (e.g., a comparison operation) based on the source address register 24 and the target address register 23. For example, when the compare enable bit is set to a first binary value (e.g., “0”), the DMA controller may not perform an operation (e.g., a comparison operation). For example, when the compare enable bit is set to a second binary value (e.g., “1”), the DMA controller 11 may perform an operation (e.g., a comparison operation). For example, the DMA controller 11 may compare the transfer data indictor 18 identified by the address 31 in the source address register 24 with the data 30 of the target address register 23. If the identified transfer data indicator 18 matches the data 30 of the target address register 23, the DMA controller may set a compare status bit 34 (FIG. 3) of the control status register 13 to a second binary value (e.g., “1”). A match may indicate that the target 15 is full.

The branch enable bit 29 may indicate to the DMA controller 11 when to perform an operation (e.g., a branch operation). For example, with the branch operation, the DMA controller may determine which descriptor to fetch next from the memory 16. The branch operation may be based on the compare status bit 34 (FIG. 3) of the control status register 13.

The descriptor address register 25 may include an address 32 of a next descriptor in the descriptor chain and a stop bit 33. The next descriptor may be stored in the memory 16. The stop bit may indicate an end to a non-cyclic descriptor chain. For example, when the stop bit is set to a first binary value (e.g., “0”), the descriptor chain may continue, and the DMA controller 11 may transfer data via the DMA channel and thereafter may fetch the next descriptor according to the address 32 in the descriptor address register 25. When the stop bit 26 is set to a second binary value (e.g., “1”), the end of the descriptor chain may be reached, and the processor 19 may deactivate the DMA channel 20. For a cyclic descriptor chain, the stop bit 33 may be set to the first binary value (e.g., “0”) for each descriptor.

FIG. 3 shows a control status register for an exemplary embodiment of the invention. The control status register 13 of the DMA controller 11 may include a compare status bit 34. The compare status bit 34 may be set by the comparison operation performed by the DMA controller 11 and may indicate whether the target 15 is full. When the compare status bit 34 is set to a first binary value (e.g., “0”), the data in the source 14 identified by the address 31 in the source address register 24 may not match the data 30 in the target address register 23, which may indicate that the target 15 is not full. When the compare status bit is set to a second binary value (e.g., “1”), the data in the source 14 may be identified by the address 31 in the source address register 24 matches the data 30 of the target address register 23, which may indicate that the target 15 is full.

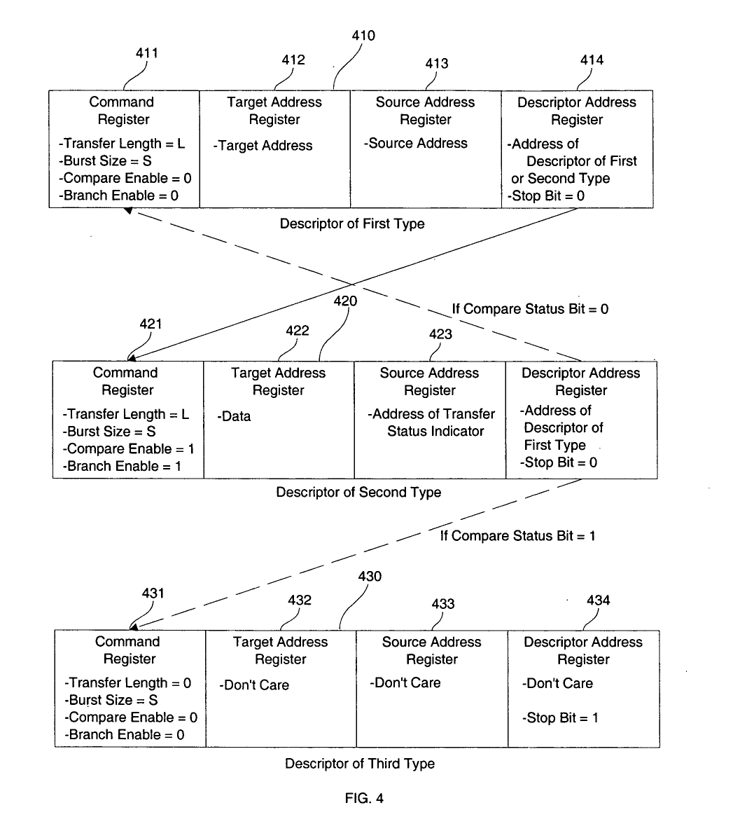

FIG. 4 shows a DMA register holding three exemplary types of descriptors in a descriptor chain for an exemplary embodiment of the invention. Each of the three types of descriptors 410, 420, and 430 may have the same structure as the descriptor as held in the DMA register 12 in FIG. 2. Descriptor 410 may be a descriptor of a first type, descriptor 420 may be a descriptor of a second type, and descriptor 430 may be a descriptor of a third type. Descriptors of the three types may be chained together to form a descriptor chain. For illustration purposes, each type of descriptor is shown as being held in the DMA register 12.

The descriptors 410, 420, and 430 may be part of a non-cyclic descriptor chain. For a cyclic descriptor chain, descriptors 410 and 420, but not descriptor 430, may be part of a cyclic descriptor chain.

The descriptor 410 may be a descriptor located anywhere in the descriptor chain. The descriptor 410 of the first type may include data for a command register 411, a target address register 412, a source address register 413, and a descriptor address register 414. For the command register 411, the transfer length may be set to L bytes, the burst size may be set to S bytes, the compare enable bit may be set to a first binary value (e.g., “0”) indicating the DMA controller is not to perform a comparison operation, and the branch enable bit may be set to a first binary value (e.g., “0”) indicating the DMA controller is not to perform a branch operation. The target address register 412 may include an address for the target 15. The source address register 413 may include an address for the source 14. The descriptor address register 414 may include an address for the memory 16 identifying the next descriptor in the descriptor chain, which may be a descriptor of the second type. The descriptor address register 414 may also include the stop bit set to a first binary value (e.g., “0”) indicating the end of the descriptor chain is not reached.

The descriptor 420 of the second type may be a descriptor to indicate to the DMA controller that a compare operation and a branch operation need to be performed. The descriptor 420 of the second type may include data for a command register 421, a target address register 422, a source address register 423, and a descriptor address register 424. For the command register 421, the transfer length may be set to L bytes (or to do not care), the burst size may be set to S bytes (or to do not care), the compare enable bit may be set to a second binary value (e.g., “1”) indicating the DMA controller is to perform a comparison operation, and the branch enable bit may be set to a second binary value (e.g., “1”) indicating the DMA controller is to perform a branch operation. The target address register 422 may include data. The source address register 423 may include an address for the transfer status indicator 18. The descriptor address register 424 may include a next descriptor in the descriptor chain, which may be a descriptor of the first type. The descriptor address register 424 may also include the stop bit set to a first binary value (e.g., “0”) indicating the end of the descriptor chain is not reached.

The descriptor 430 of the third type may be a descriptor to indicate that the data transfer must be stopped. The data transfer may be stopped because, for example, the target 15 is full or the end of a non-cyclic descriptor chain is reached. The descriptor 430 of the third type may include data for a command register 431, a target address register 432, a source address register 433, and a descriptor address register 434. For the command register 431, the transfer length may be set to 0 bytes, the burst size may be set to 0 bytes, the compare enable bit may be set to a first binary value (e.g., “0”) indicating the DMA controller may perform a comparison operation, and the branch enable bit may be set to a first binary value (e.g., “0”) indicating the DMA controller may not perform a branch operation. The target address register 432 may include a do not care entry for the address of the target 15. The source address register 433 may include a do not care entry for the address of the source 14. The descriptor address register 434 may include a do not care entry for the address of the memory 16 and may also include the stop bit set to a second binary value (e.g., “1”). The transfer length in the command register 431 being set to 0 bytes and the stop bit in the descriptor address register 434 being set to a second binary value (e.g., “1”) may indicate that data transfer is to be stopped and that the DMA channel is to be deactivated.

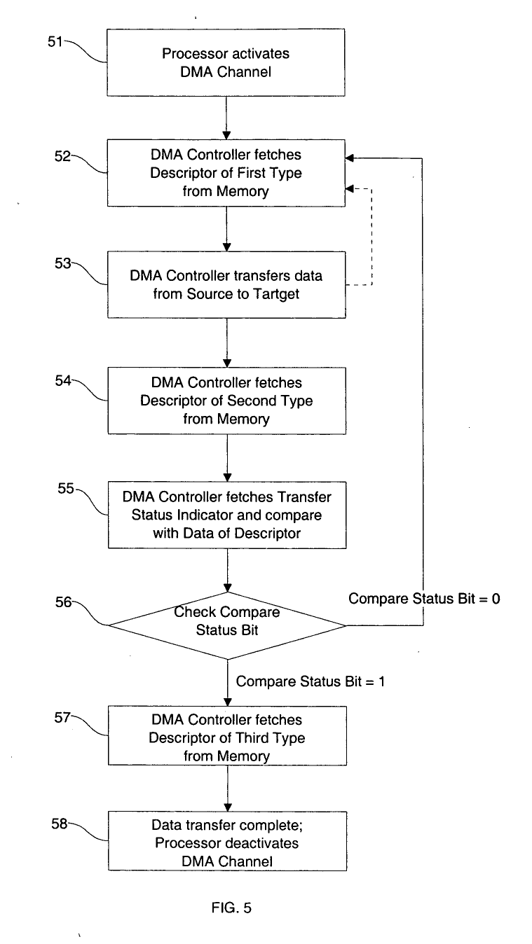

FIG. 5 shows a flow diagram for data transfer for an exemplary embodiment of the invention. The flow diagram of FIG. 5 is discussed with respect to FIGS. 1-4.

In block 51, the processor 19 may activate the DMA channel 20.

In block 52, the DMA controller 11 may fetch a descriptor 410 of the first type from the memory 16 and may hold the fetched descriptor in the DMA register 12. The fetched descriptor may be the first descriptor in a descriptor chain or a next descriptor in the descriptor chain identified by a previous descriptor in the descriptor chain.

In block 53, the DMA controller 11 may transfer data from the source 14 to the target 15 via the DMA channel 20. The address of the data in the source 14 may be identified by the address of the source address register 412. The address to place the data in the target 15 may be identified by the address of the target address register 413. The data may be transferred from the source 14 to the target 15 based on the transfer length and the burst size identified in the command register 411.

Blocks 52 and 53 may be repeated as long as the descriptor address register 414 identifies a descriptor of the first type. When the descriptor address register 414 identifies an address for a descriptor 420 of the second type, flow may proceed to block 54.

In block 54, the DMA controller may fetch a descriptor 420 of the second type from the memory 16 and hold the fetched descriptor in the DMA register 12. The fetched descriptor may be identified by the descriptor address register 414 of the previous descriptor 410. In the command register 421 of descriptor 420, the compare enable bit may be enabled, and the branch enable bit may be enabled.

In block 55, the DMA controller 11 may fetch the transfer status indicator identified by the address in the source address register 423. The compare enable bit being set to a second binary value (e.g., “1”) may indicate to the DMA controller that a comparison operation is to be performed. For the comparison operation, the DMA controller 11 may compare the fetched transfer status indicator with the data in the target address register 422 and may update the compare status bit 34 in the control status register 13 accordingly. For example, if the fetched transfer status indicator matches the data from the target address register 422, the DMA controller 11 may set the compare status bit 34 in the control status register 13 to the second binary value (e.g, “1”). For example, if the fetched data from the source 14 does not match the data from the target address register 422, the DMA controller 11 may set the compare status bit 34 in the control status register 13 to the second binary value (e.g, “0”). A match may indicate that the data transfer may need to be stopped shortly due to the target 15 being full or nearly full.

In block 56, the DMA controller checks the compare status bit 34. The branch enable bit being set to a second binary value (e.g., “1”) may indicate to the DMA controller that a branch operation is to be performed. As part of the branch operation, the DMA may check the compare status bit. For example, if the compare status bit 34 is set to the first binary value (e.g., “0”) indicating no match and that the data transfer does not need to be stopped, flow may proceed to block 52, and the DMA controller 11 may fetch a next descriptor of the first type from the memory 16 in block 52. If the compare status bit is set to the second binary value (e.g., “1”) indicating a match, flow may proceed to block 57.

In block 57, the DMA controller may fetch a descriptor 430 of the third type from the memory 16 and may hold the fetched descriptor in the DMA register 12. The location of the descriptor 430 of the third type may be, for example, determined by an offset from the address of the previous descriptor 420 or located at a predetermined address of the memory 16.

In block 58, no further data transfer may be performed. In the target address register 431 of descriptor 430, the transfer length may be set to 0 bytes, the burst size may be set to 0 bytes, and/or the stop bit may be set to 1, which may indicate that data transfer is to be stopped. The processor 19 may deactivate the DMA channel 20.

In the above exemplary embodiments, the compare enable bit 28 and the branch enable bit 29 may indicate when the DMA controller 11 is to perform a compare operation and a branch operation, respectively. In FIG. 4, the compare enable bit 28 and the branch enable bit 29 may be enabled simultaneously (i.e., set to a second binary value (e.g., “1”)). In another exemplary embodiment of the invention, the compare enable bit 28 and the branch enable bit 29 may be enabled in separate descriptors. For example, in descriptor N of the descriptor chain, the compare enable bit may be set to a second binary value (e.g., “1”), and the compare enable bit may be set to a second binary value (e.g., “0”). In descriptor N+M of the descriptor chain, the compare enable bit may be set to a first binary value (e.g., “0”), and the compare enable bit may be set to a second binary value (e.g., “1”). During data transfer, the DMA controller 11 may perform the comparison operation for descriptor N and the branch operation for descriptor N+M.

In the above exemplary embodiments, the compare enable bit 28 and the branch enable bit 29 may indicate when the DMA controller 11 is to perform a compare operation and a branch operation, respectively. In another exemplary embodiment, instead of using two bits, a single bit may be used to indicate when the DMA controller 11 is to perform a compare operation and a branch operation.

With the invention, for example, the DMA controller 11 may control and monitor the data transfer process (e.g., data transfer from the source 14 to the target 15). The processor 19 may be responsible for activating and deactivating the DMA channel 20 and may not be responsible for controlling and monitoring the data transfer process. For example, the processor 19 may not be responsible for determining if the target 15 becomes full during data transfer. Because the processor 19 may not control and monitor the data transfer process, the processor 19 may perform other operations or be placed in a low power mode (e.g., an idle mode). Further, because the processor 19 may not control and monitor the data transfer process, interrupts and interrupt handlers for the processor 19 may not be needed to control and monitor the data transfer process.

The foregoing description is intended to be illustrative and not limiting. Variations will occur to those of skill in the art. Those variations are intended to be included in the various embodiments of the invention, which are limited only by the spirit and scope of the appended claims.

1. An apparatus, comprising:
a direct memory access register adapted to hold a descriptor, said register comprising:
a command register comprising a compare enable bit and a branch enable bit;
a source address register;
a target address register; and
a descriptor address register.

2. An apparatus as in claim 1, wherein said compare enable bit is adapted to indicate a comparison operation to be performed by said direct memory access controller based on said source address register and said target address register.

3. An apparatus as in claim 1, wherein said branch enable bit is adapted to indicate a branch operation to be performed by said direct memory access controller to access another descriptor.

4. An apparatus as in claim 1, further comprising a control status register, said control status register comprising a compare status bit.

5. An apparatus as in claim 4, wherein said branch enable bit is adapted to indicate a branch operation to be performed by said direct memory access controller to access another descriptor based on said compare status bit.

6. A system, comprising:
a target;
a source;
a memory adapted to contain a first descriptor of a first type, a second descriptor of a second type, a third descriptor of a third type, and a fourth descriptor of said first type;
a direct memory access controller coupled to said memory, said direct memory access controller adapted to transfer data from said source to said target based on said first descriptor, said direct memory access controller comprising a direct memory access register to hold said first descriptor, said second descriptor, or said third descriptor, said direct memory access register comprising a command register comprising a compare enable bit and a branch enable bit.

7. A system as in claim 6, said direct memory access register further comprising a source address register and a target address register.

8. A system as in claim 7, wherein said compare enable bit is adapted to indicate a comparison operation to be performed by said direct memory access controller based on said source address register and said target address register.

9. A system as in claim 6, wherein said branch enable bit is adapted to indicate a branch operation to be performed by said direct memory access controller to fetch said fourth descriptor or said third descriptor from said memory.

10. A system as in claim 9, wherein said first descriptor is adapted to indicate data transfer by said direct memory access controller, and wherein said third descriptor is adapted to indicate no data transfer by said direct memory access controller.

11. A system as in claim 6, said direct memory access controller further comprising a control status register, said control status register comprising a compare status bit.

12. A system as in claim 11, wherein said branch enable bit is adapted to indicate a branch operation to be performed by said direct memory access controller to fetch said fourth descriptor or said third descriptor from said memory based on said compare status bit.

13. A system as in claim 11, wherein said direct memory access controller is adapted to perform a comparison operation and a branch operation based on said branch enable bit, said comparison enable bit, and said compare status bit.

14. A machine-readable medium that provides instructions, which when executed by a computing platform, cause said computing platform to perform operations comprising a method of:
fetching a first descriptor of a first type, said first descriptor identifying a first source and a first target;
transferring a first data set over a direct memory access channel from said first source to said first target based on said first descriptor;
fetching a second descriptor of a second type, said second descriptor identifying a second source, said second descriptor comprising comparison data;
fetching data from said second source identified by said second descriptor;
comparing said data fetched from said second source and said comparison data to obtain a comparison result; and
fetching one of a fourth descriptor of said first type and a third descriptor of a third type based on said comparison result.

15. A machine-readable medium as in claim 14, wherein said fourth descriptor is fetched if said comparison result indicates said data fetched from said second source fails to match said comparison data.

16. A machine-readable medium as in claim 14, wherein said third descriptor is fetched if said comparison result indicates said data fetched from said second source matches said comparison data.

17. A machine-readable medium as in claim 14, wherein said second descriptor comprises a branch enable bit and a comparison enable bit, wherein said comparing data fetched is based on said comparison enable bit in said second descriptor, and said fetching one of said fourth descriptor and said third descriptor is based on said branch enable bit in said second descriptor.

18. A machine-readable medium as in claim 14, wherein said data fetched from said second source comprises a transfer status indicator.

19. A method, comprising:
fetching a first descriptor of a first type, said first descriptor identifying a first source and a first target;
transferring a first data set over a direct memory access channel from said first source to said first target based on said first descriptor;
fetching a second descriptor of a second type, said second descriptor identifying a second source, said second descriptor comprising comparison data;
fetching data from said second source identified by said second descriptor;
comparing said data fetched from said second source and said comparison data to obtain a comparison result; and
fetching one of a fourth descriptor of said first type and a third descriptor of a third type based on said comparison result.

20. A method as in claim 19, wherein said fourth descriptor is fetched if said comparison result indicates said data fetched from said second source fails to match said comparison data.

21. A method as in claim 19, wherein said third descriptor is fetched if said comparison result indicates said data fetched from said second source matches said comparison data.

22. A method as in claim 19, wherein said second descriptor comprises a branch enable bit and a comparison enable bit, wherein said comparing data fetched is based on said comparison enable bit in said second descriptor, and said fetching one of said fourth descriptor and said third descriptor is based on said branch enable bit in said second descriptor.

23. A machine-readable medium as in claim 19, wherein said data fetched from said second source comprises a transfer status indicator.
